(19) United States
(12) Patent Application Publication
(10) Pub. No.: US 2017/0344698 A1
(43) Pub. Date: Nov. 30, 2017

(54) Evidence based system and method for identifying factors of disease

(71) Applicant: Jennifer Griffin, Gatesville, TX (US)

(72) Inventor: Jennifer Griffin, Gatesville, TX (US)

(21) Appl. No.: 15/530,849

(22) Filed: Mar. 8, 2017

Related U.S. Application Data
(60) Provisional application No. 62/305,955, filed on Mar. 9, 2016.

(51) Int. Cl. G06F 19/12; G06F 19/18; G06F 19/00; G06F 19/28

(52) U.S. Cl. CPC G06F 19/12; G06F 19/322; G06F 19/18; G06F 19/28

(57) ABSTRACT

A repeatable methodology for generation of a specific biological function library (data pool) and techniques for structuring queries that cluster and parse gene and protein alterations in individual patients and patient cohorts. Method enables analytical distinction between detectable changes in biological function and non-detectable changes in biological function using current diagnostic techniques and technologies.

### CROSS-REFERENCE TO RELATED APPLICATIONS

This application claims priority for purposes of this application to U.S. Provisional Application Ser. No. 62/305,955, entitled “Evidence Based System and Method for Identifying Factors of Disease,” and filed 9 Mar. 2016.

### DESCRIPTION

### Field of the Invention

The present invention relates to the field of medicine. More particularly, the present invention provides a repeatable method for development of specific biological function libraries and their use to identify clusters of genes and/or protein expression alterations within individual patients; clusters of patients carrying genes and/or protein expression alterations; and clusters of genes and/or protein alterations in a disease.

### Background

The human body is a highly complex system of systems. The level of diversity across the human race in cognitive, physical and emotional attributes is astounding. Yet, despite this diversity there is a tremendous amount of commonality in form and function across all human beings. Essentially, there are four critical networks that work together to sustain human life: the ability to consume resources and generate energy to do work, the ability to clear or excrete byproducts of doing work from our cells, the ability to grow (adapt) and maintain (repair) our systems, and finally the ability to defend against “invaders” that do us harm.

The Gene Ontology Consortium created the Gene Ontology Project (GO) in an effort to cluster scientific knowledge of molecular, cellular, and tissue systems. One of the major GO contributions is that of a universal taxonomy with which to classify normal characteristics of gene product functionality. Unfortunately, the GO terms do not help in identifying critical thresholds where abnormal molecular changes manifest disease.

The Cancer Genome Atlas (TCGA) Research Network was established to generate a publicly available “catalog of molecular alterations” for various cancers. The TCGA Research network found an overlap in somatic mutations, however it is unclear if a core set of specific genes with critical functionality are consistently altered across molecular and epigenetic subtypes.

The majority of current genome research studies analyze genomic data using a heuristic “centroid” approach where data is grouped into K clusters by proximity. Essentially, genetic variation across an entire genome drives how and where genes cluster into groups.

Several repositories, such as the METLIN database developed by the Scripps Center for Metabolomics and the Human Metabolome Database (HMDB), have been developed to maintain chemical and molecular biology data.

Cell and tissue culture experiments, to include live animal models, are time consuming and typically focus on a small subset of genes or proteins of interest or pharmaceutical therapies. Thus, the number of experimental subjects, gene targets, and pharmaceutical dosages that can be completed at one time are limited by researcher resources and time.

Somatic mutations in a gene are non-heritable alterations in the DNA sequence. Epigenetic changes that modify the activation of certain genes without changing the DNA sequence are preserved when cells divide. Alteration of non-coding DNA sequences can impact activation of coding sequences.

Many diseases do not have a known underlying environmental, demographic or biological factor.

All critical functional networks have multiple genes in multiple pathways. Thus, the mutation of different genes within a pathway can compromise a network. Therefore, we could have patients who have a different subset of somatic gene mutations and develop disease. Disease then may arise from compromise of several pathways within one of the four critical networks.

Alternatively, disease may arise as an aggregate effect where some threshold of pathways in all four networks are compromised.

### SUMMARY

The present invention provides a repeatable method to identify common underlying disease factors by leveraging current findings across the field of study.

By analyzing gene mutation data we can obtain evidence of non-heritable DNA sequence changes occurring in a disease. Gene expression data potentially provides information on the functional effects of gene mutations. By combining the list of genes with changes in protein expression to the list of genes with mutations we have a more complete picture of specific biological factors or functions in a given disease.

### BRIEF DESCRIPTION OF THE DRAWINGS

This repeatable method is intended to identify the alteration status of genes and/or proteins known to impact specific biological functions in a disease of interest.

FIG. 1A Overview of repeatable methodology.

FIG. 1B Process for generating specific biological function gene library or data pool.

FIG. 1C Query of gene library or data pool with patient cohort data.

FIG. 1D Identification of disease factors.

### DETAILED DESCRIPTION

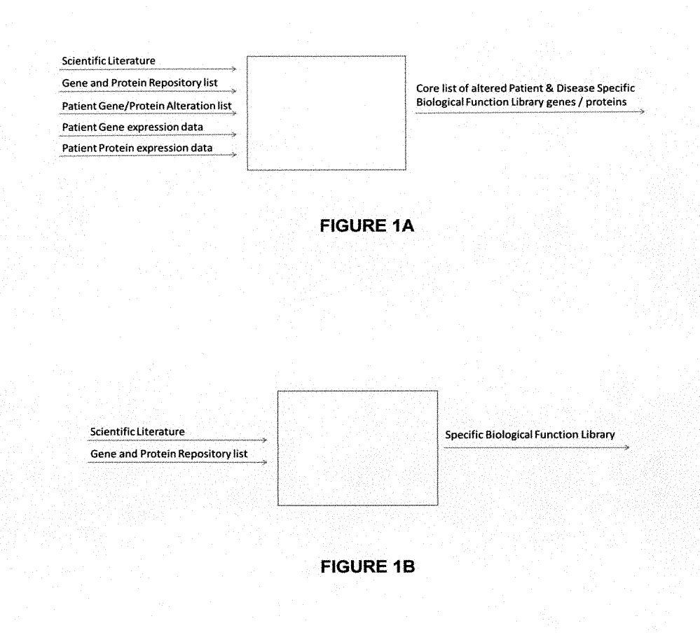

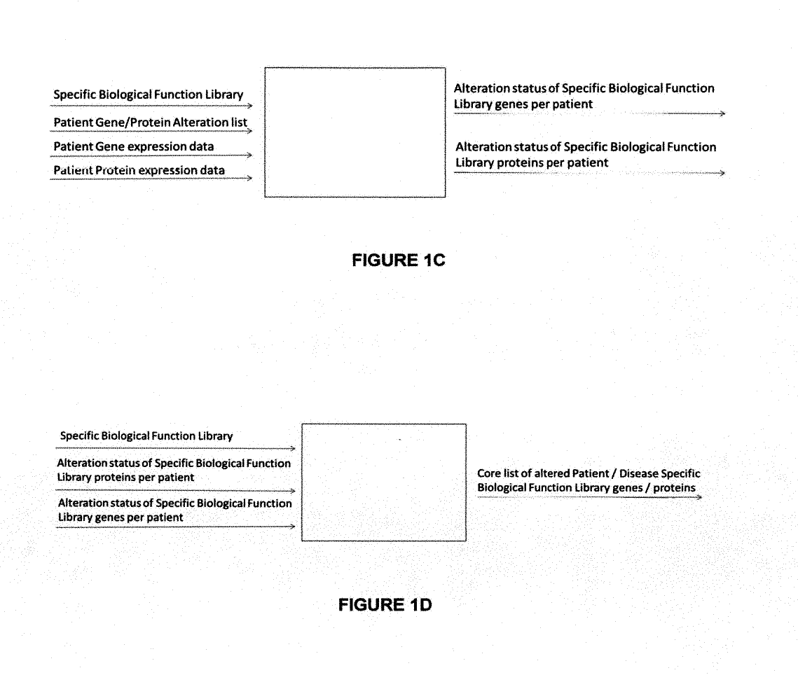

FIG. 1A presents one embodiment of the overall methodology. According to an embodiment of the invention, a review of human and animal studies for a disease of interest is done to identify specific biological functions/factors. This review of scientific literature will result in the generation of an initial listing of biological functions in our disease of interest and the genes and proteins that regulate them. For example, the following sources can be used to seed the biological functions list:
Review pathology focused postmortem publications
Review genomics and proteomic focused publications
Review cell signaling focused publications

In an embodiment of the invention, a next step can be review of an authoritative repository, such as METLIN or KEGG, for a listing of genes pertinent to our initial biological function list. FIG. 1B illustrates how lists such as these are combined to generate our Specific Biological Function Library. An example of four lists our methodology can create:
Functional gene lists extracted from an authoritative repository
Cohort list of patients with gene mutations
Cohort list of patients with genes that have altered expression data
Cohort list of patients with genes that have altered protein expression data

Other embodiments of this invention, as seen in FIG. 1C, multiple queries can then be generated against this biological function library. For example, three search and sort functions can be run:
Search Patient Cohort list of gene mutations for genes extracted from authoritative repository
Search Patient Cohort list of genes with altered expression for genes extracted from authoritative repository
Search Patient Cohort list of genes with alterations in protein expression data for genes extracted from authoritative repository

In an embodiment of the invention, any query of the Specific Biological Function Library will return a response with the following three categories:
Name and number of altered genes/proteins detected in patient cohort
Name and number of non-altered genes/proteins detected in patient cohort
Name and number of genes/proteins not detected in patient cohort

FIG. 1D then reveals analysis that can be conducted using an embodiment of the Specific Biological Function Library to identify gene or protein alterations implicated in a specific disease or patient population. An example of two analytical functions:
Compare results from the above searches to generate a cumulative listing of genes mutated/altered in the disease of interest for a cohort
Compare cumulative listing of genes mutated/altered in the disease of interest for multiple cohorts

An embodiment of this invention is intended to extract specific biological function information from all existing scientific literature published to create a library that can screen patient data for patterns of gene and/or protein alterations within and across cohort data sets: these patterns can be clusters of patients carrying mutations/alterations for particular genes and/or proteins, or particular mutations/alterations of particular genes and/or proteins in a given disease; or clusters of genes and/or proteins mutated/altered together. As illustrated in FIG. 1D one embodiment of this invention then can be used to determine whether or not a collection of genes that regulate specific biological functions impact individual patient outcome and disease progression.

The field currently relies on two approaches: 1) detecting sequencing and expression changes in the whole genome and 2) searching the genome for alterations in a small subset of genes or proteins. The results of these analysis are then regarded as the definitive sequence or expression for a given individual and disease. One embodiment of this invention creates a library that combines the information from both of these approaches. Furthermore, diagnostic techniques and analysis are narrowly focused to report only what genetic or proteomic alterations a given test reports. Analysis does not include assessment of functional genes that were not detected. However, knowing the genes or proteins that were not detected but are known to have a role in a specific biological function can provide valuable insight to the researcher such as alerting to potential protocol or diagnostic issues. By querying molecular data for specific functional genes and proteins, my method allows a deeper understanding of what it is our diagnostics are and are not reporting.

The logic and processes described in this document may be implemented in software, firmware, hardware or any combination thereof. Furthermore, execution of said logic and processes can occur across a distributed architectural environment, a strictly local computing environment or any combination thereof. It is therefore intended that the scope of the invention be limited not by this detailed description, but rather by any claims that issue on an application based hereon. The phrase “in one embodiment” or “in an embodiment” in the specification does not necessarily refer to the same embodiment, nor are separate or alternative embodiments mutually exclusive of other embodiments. Explicit reference to an “embodiment” or the like, steps and functions are described, which may be variously combined and included in some embodiments, but also variously omitted in other embodiments. Consequently, the disclosure of the embodiments of the invention is provided for explanatory purposes, without limiting the scope of the invention, as set forth in the following claims.

1-12. (canceled)

13. A computer implemented method that:
receives input of all reference information pertinent to biological functions and input of information for individual patients;
information specific to a cohort of patients; and
disease specific information.

14. A computer implemented method that:
generates a biological function library or data pool incorporating all reference data; and share content with other users if desired; and
enables the user to create and/or select additional versions of the biological function library to meet specific objective(s), using various alternate versions of the reference content from the first version of the biological function library, with iterative versions of the content being a different version and/or arrangement of the same content as the first version of the content.

15. A computer implemented method that:
provides for display and storage, listing and reference information pertaining to all specific biological function genes and/or proteins altered/mutated in individual patients, a patient cohort and/or a given disease;
listing and reference information pertaining to all specific biological function genes and/or proteins not altered/not mutated in individual patients, a patient cohort and/or a given disease; and
listing and reference information pertaining to all specific biological function genes and/or proteins not detected in individual patients, a patient cohort and/or a given disease.
